(19) United States
(12) Patent Application Publication
(10) Pub. No.: US 2008/0149888 A1
(43) Pub. Date: Jun. 26, 2008

(54) Storage Medium and Method For Storing Hydrogen

(76) Inventors: Robert Adler, Gerasdorf (AT); Roland Kalb, Wien (AT); Wolfgang Wesner, Wr. Neustadt (AT)

Correspondence Address: CROWELL & MORING LLP;INTELLECTUAL PROPERTY GROUP, P.O. BOX 14300, WASHINGTON, DC, 20044-4300, US

(21) Appl. No.: 11/575,960

(22) PCT Filed: Sep. 20, 2005
(86) PCT No.: PCT/EP05/10147

§ 371 Date: Oct. 31, 2007

(30) Foreign Application Priority Data
Oct. 1, 2004 (DE) 10 2004 047 986.0

(51) Int. Cl. C09K 3/00; C07C 211/62; C07F 9/54; C07C 317/00

(52) U.S. Cl. 252/184; 564/281; 568/9; 568/18

(57) ABSTRACT

A storage medium and a method for storing hydrogen is disclosed. The storage medium has at least one ionic compound capable of hydrogenation or consists at least partially of at least one ionic compound capable of hydrogenation. The ionic compounds are present in liquid and/or solid form.

### BACKGROUND AND SUMMARY OF THE INVENTION

This application claims the priority of International Application No. PCT/EP2005/010147, filed Sep. 20, 2005, and German Patent Document No. 10 2004 047 986.0, filed Oct. 1, 2004, the disclosures of which are expressly incorporated by reference herein.

The invention relates to a storage medium and to a method for storing hydrogen.

The storage and distribution of hydrogen can be effected in different ways. For example, hydrogen can be stored in compressed form in suitable high-pressure tanks which allow storage at up to a pressure of 875 bar.

Further, storage of the liquefied low-temperature hydrogen in suitable cryogenic containers, preferably in superinsulated cryogenic containers is known. The last named possibility is implemented in particular with hydrogen-powered vehicles—independently of whether they are powered by means of a modified combustion engine or by means of a fuel cell which drives an electric motor.

Storage systems are in the experimental stage in which the storage of the hydrogen takes place in organic compounds capable of hydrogenation which are able to chemically bind the hydrogen. Such storage systems are known under the designations MPH (methylcyclohexane poluene hydrogen), decaline/napthalene and n-heptane/toluene system.

Common to the aforementioned systems is that the hydrogen is brought to reaction with them under suitable conditions so that hydrogenation and storage of the hydrogen results.

All the aforementioned alternatives have specific advantages and disadvantages so that the decision in favor of one of the alternatives is usually determined by the specific applications and circumstances. The fundamental disadvantage of the last-named alternative until now has been that the chemical reaction systems used have relatively high vapor pressures, are thus volatile and contaminate the hydrogen to a considerable degree.

To achieve high degrees of purity for the hydrogen in particular, such reaction systems must, therefore, be removed, often at great expense in terms of technology and/or energy.

The person skilled in the art is continuously striving to create a storage potential for hydrogen which allows storage of the hydrogen in a pure or absolutely pure form, where storage should be possible in the safest and most economical manner possible. Hydrogen is needed in a very pure form particularly in the operation of fuel cells. In the case of the modified combustion engines mentioned as well, which usually have a downstream catalytic converter, storage of the hydrogen in (ultra)pure form is striven for since otherwise the hydrocarbons entrained with the hydrogen (may) have a negative effect on the activity and life of the catalytic converter. Particularly in the use of hydrogen in the so-called mobile applications—operation of vehicles, etc.—the safety aspect is paramount; this applies especially for the refueling process which is usually performed by the driver himself and therefore by a “technical layman.”

To solve the aforementioned problems, a storage medium for storing hydrogen is provided the characteristic of which is that the storage medium has at least one ionic compound capable of hydrogenation or consists at least partially of at least one ionic compound capable of hydrogenation.

In a similar way with the method in accordance with the invention for storing hydrogen, storage of the hydrogen takes place in a storage medium which has at least one ionic compound capable of hydrogenation or consists at least partially of at least of one ionic compound capable of hydrogenation.

In this, the ionic compounds used are preferably available in liquid and/or solid form.

### DETAILED DESCRIPTION OF THE EXEMPLARY EMBODIMENTS

Ionic compounds capable of hydrogenation which are available in liquid form are designated as ionic fluids in what follows. In a similar way, ionic compounds capable of hydrogenation which are available in solid form are designated as ionic solids.

Ionic compounds capable of hydrogenation are, consequently, ionic fluids or ionic solids which possess the ability to bind hydrogen chemically.

Ionic fluids are low-boiling, organic salts with melting points between 100 and −90° C., where most of the known ionic fluids are already present in liquid form at room temperature. In contrast to conventional molecular fluids, ionic fluids are completely ionic and thus reveal new and unusual properties. Ionic fluids are comparatively easily adaptable in their properties to given technical problems as a result of the variation in the structure of anion and/or cation and the variation in their combinations. For this reason they are frequently also described as “designer solvents.” With conventional molecular fluids on the other hand, only a variation in the structure is possible.

In contrast to conventional molecular fluids, ionic fluids have the additional advantage that they possess no measurable vapor pressure. This means that—as long as their decomposition temperature is not reached—they do not evaporate in the slightest, even in a total vacuum. From this result their properties of non-flammability and environmental friendliness since ionic fluids consequently cannot reach the atmosphere.

As already mentioned, the melting points of known ionic fluids are by definition below 100° C. The liquidus range—the range between melting point and thermal decomposition—is usually 400° C. or higher.

In addition, ionic fluids have very high thermal stability. Their decomposition points are frequently above 400° C. In the case of ionic fluids, their density and mixing characteristics with other fluids can be affected, or adjusted, with ionic fluids through the choice of ions. Ionic fluids have the additional advantage that they are electrically conductive and as a result can prevent static electrical charges—which represent a potential hazard.

In what follows, the term “ionic solids” is understood to mean salts in the sense of the ionic fluids described previously which have a melting point of at least 100° C. Beyond that, no chemical and physical differences exist in principle between ionic fluids and ionic solids in the sense of the aforementioned definition.

If the storage medium in accordance with the invention is brought into reaction with hydrogen under suitable conditions (pressure, temperature, catalysts, introduction of the hydrogen into the ionic fluid, etc.), hydrogenation takes place whereby the hydrogen is bonded to or embedded in the storage media in accordance with the invention.

Discharge of the storage medium in accordance with the invention takes place when the stored hydrogen is released.

In order to ease the energy demand for the reversal reaction, the release of hydrogen from the storage medium in accordance with the invention, the latter—in accordance with an advantageous embodiment of the invention—has at least one conjugated, preferably aromatic pi-electron system. This pi-electron system can be in the cationic part, in the anionic part or both the aforementioned parts; further, several pi-electron systems in resonance with each other or separate can be united in one molecule. Further stabilization of the pi-electron of the dehydrogenated form, or destabilization of the hydrogenated form—in the thermodynamic sense—is achieved by derivatization with suitable substituents. The interaction of these substituents with the pi-electron system takes place through inductive, mesomeric and/or field effects.

The cation in question (Q+)ₙ is a quaternated ammonium-(R¹R²R³R⁴N⁺), phosphonium-(R¹R²R³R⁴P⁺) and/or sulfonium cation (R¹R²R³S⁺) and/or a similar quaternated nitrogen, phosphorus or sulfur-heteroaromatic, where the aforementioned radicals R¹, R², R³ and R⁴ may be the same, partially the same or different. These radicals may be linear, cyclic, branched, saturated and/or unsaturated alkyl radicals, mono- or polycyclic aromatic or heteroaromatic radicals and/or derivatives of these radicals substituted with additional functional groups, where R¹, R², R³ and R⁴ may also be bonded among each other.

All known organic and inorganic anions can be used as anions. In accordance with an advantageous embodiment of the storage medium in accordance with the invention, anions capable of hydrogenation are used.

The storage medium in accordance with the invention as well as the method for storing hydrogen in accordance with the invention create a storage potential for hydrogen which—compared with the prior art—has greater environmental compatibility and substantial safety advantages.

1-12. (canceled)

13. A storage medium for storing hydrogen, wherein the storage medium has an ionic compound capable of hydrogenation or consists partially of an ionic compound capable of hydrogenation.

14. The storage medium according to claim 13, wherein the ionic compounds are present in liquid and/or solid form.

15. The storage medium according to claim 13, wherein the storage medium in a charged and/or uncharged state shows no measurable vapor pressure below its decomposition temperature.

16. The storage medium according to claim 13, wherein the storage medium has an electrical conductivity of at least 0.01 mS/cm.

17. The storage medium according to claim 13, wherein the ionic compound capable of hydrogenation is formed from an organic salt and/or an organic salt mixture consisting of organic cations and organic and/or inorganic anions.

18. The storage medium according to claim 17, wherein the cations are a quaternated ammonium-(R¹R²R³R⁴N⁺), phosphonium-(R¹R²R³R⁴P⁺) and/or sulfonium cation (R¹R²R³S⁺) and/or a similar quaternated nitrogen, phosphorus or sulfur-heteroaromatic, where the radicals R¹, R², R³ and R⁴ may be a same radical, partially the same, or different.

19. The storage medium according to claim 18, wherein the radicals R¹, R², R³ and R⁴ may be linear, cyclic, branched, saturated and/or unsaturated alkyl radicals, mono- or polycyclic aromatic or heteroaromatic radicals and/or derivatives of these radicals substituted with additional functional groups, and/or the radicals R¹, R², R³ and R⁴ are bonded among each other.

20. The storage medium according to claim 17, wherein the anions are anions capable of hydrogenation.

21. The storage medium according to claim 13, wherein the ionic compound capable of hydrogenation permits a physical binding of the hydrogen.

22. A method for storing hydrogen, wherein the storage of the hydrogen takes place on a storage medium which has an ionic compound capable of hydrogenation or consists partially of an ionic compound capable of hydrogenation.

23. The method according to claim 22, wherein the storage medium shows no measurable vapor pressure below its decomposition temperature in a charged and/or uncharged state.

24. The method according to claim 22, wherein the storage medium has an electrical conductivity of at least 0.01 mS/cm.

25. A storage medium for hydrogen, comprising:
an ionic compound; and
hydrogen stored with the ionic compound.

26. The storage medium according to claim 25, wherein the ionic compound is an ionic fluid.

27. The storage medium according to claim 25, wherein the ionic compound is an ionic solid.

28. The storage medium according to claim 25, wherein the hydrogen is bonded to the ionic compound.

29. The storage medium according to claim 25, wherein the hydrogen is embedded in the ionic compound.

30. A method for storing hydrogen, comprising the steps of:
storing the hydrogen with an ionic compound.

31. The method according to claim 30, wherein the step of storing the hydrogen with an ionic compound includes bonding the hydrogen to the ionic compound.

32. The method according to claim 30, wherein the step of storing the hydrogen with an ionic compound includes embedding the hydrogen in the ionic compound.

33. The method according to claim 30, further comprising the step of releasing the hydrogen from the ionic compound with a conjugated aromatic pi-electron system.
